(19) United States
(12) Patent Application Publication
(10) Pub. No.: US 2015/0378494 A1
(43) Pub. Date: Dec. 31, 2015

(54) OPERATING MICRO-WIRE ELECTRODES HAVING DIFFERENT SPATIAL RESOLUTIONS

(71) Applicant: RONALD STEVEN COK, Rochester, NY (US)

(72) Inventor: RONALD STEVEN COK, Rochester, NY (US)

(21) Appl. No.: 14/314,386

(22) Filed: Jun. 25, 2014

(51) Int. Cl. G06F 3/041; G06F 3/044

(52) U.S. Cl. CPC G06F 3/0416; G06F 3/044; G06F 2203/04112; G06F 2203/04111

(57) ABSTRACT

A method of operating a micro-wire electrode structure includes using a controller to receive an electrical signal from one or more first electrodes. The first electrodes have visually uniform micro-wires arranged on a surface in a surface area. Each first electrode includes two or more electrically connected micro-wires in the surface area. The controller receives an electrical signal from one or more second electrodes. The second electrodes have visually uniform micro-wires arranged on the surface in the surface area. Each second electrode includes one or more electrically connected micro-wires in the surface area. The second electrodes have a smaller electrode area and a smaller micro-wire area than the first electrodes in the surface area and the first and second electrode areas are visually uniform. A processor detects a low-spatial-resolution signal from the first electrode(s) and detecting a high-spatial-resolution signal from the second electrode(s).

### CROSS REFERENCE TO RELATED APPLICATIONS

Reference is made to commonly-assigned, co-pending U.S. patent application Ser. No. _____ (Kodak Docket K001686) filed concurrently herewith, entitled “Micro-Wire Electrodes having Different Spatial Resolutions” by Cok, the disclosure of which is incorporated herein.

### FIELD OF THE INVENTION

The present invention relates to micro-wire electrodes formed on a substrate, and in particular to visually uniform electrode having different spatial resolutions.

### BACKGROUND OF THE INVENTION

Transparent conductors are widely used in the flat-panel display industry to form electrodes for electrically switching the light-emitting or light-transmitting properties of a display pixel, for example in liquid crystal or organic light-emitting diode displays. Transparent conductive electrodes are also used in touch screens in conjunction with displays. In such applications, the transparency and conductivity of the transparent electrodes are important attributes. In general, it is desired that transparent conductors have a high transparency (for example, greater than 90% in the visible spectrum) and a low electrical resistivity (for example, less than 10 ohms/square).

Touch screens with transparent electrodes are widely used with electronic displays, especially for mobile electronic devices. Such devices typically include a touch screen mounted over an electronic display that displays interactive information. Touch screens mounted over a display device are largely transparent so a user can view displayed information through the touch-screen and readily locate a point on the touch-screen to touch and thereby indicate the information relevant to the touch. By physically touching, or nearly touching the touch screen in a location associated with particular information, a user can indicate an interest, selection, or desired manipulation of the associated particular information. The touch screen detects the touch and then electronically interacts with a processor to indicate the touch and touch location. The processor can then associate the touch and touch location with displayed information to execute a programmed task associated with the information. For example, graphic elements in a computer-driven graphic user interface are selected or manipulated with a touch screen mounted on a display that displays the graphic user interface.

Referring to FIG. 9, a prior-art display and touch-screen system 100 includes a display 110 having a display area 111. A corresponding touch screen 120 is mounted with the display 110 so that information displayed on the display 110 in the display area 111 is viewed through the touch screen 120. Graphic elements (not shown) displayed on the display 110 in the display area 111 are selected, indicated, or manipulated by touching a corresponding location on the touch screen 120. The touch screen 120 includes a first transparent substrate 122 with first transparent electrodes 130 formed in the x dimension X on the first transparent substrate 122 and a second transparent substrate 126 with second transparent electrodes 132 formed in the y dimension Y facing the x-dimension first transparent electrodes 130 on the second transparent substrate 126. A transparent dielectric layer 124 is located between the first and second transparent substrates 122, 126 and the first and second transparent electrodes 130, 132. Referring also to the plan view of FIG. 10, in this example first pad areas 128 in the first transparent electrodes 130 are located adjacent to second pad areas 129 in the second transparent electrodes 132 in the display area 111. (The first and second pad areas 128, 129 are separated into different parallel planes by the dielectric layer 124, as shown in FIG. 9, or cross over and under each other where the first and second pad areas 128, 129 overlap, not shown.) The first and second transparent electrodes 130, 132 each have a variable width and extend in orthogonal directions (for example as shown in U.S. Patent Application Publication Nos. 2011/0289771 and 2011/0099805). When a voltage is applied across the first and second transparent electrodes 130, 132, electric fields are formed between the first pad areas 128 of the first transparent electrodes 130 and the second pad areas 129 of the second transparent electrodes 132.

Referring back to FIG. 9, a display controller 142 connected through electrical buss connections 136 controls the display 110 in cooperation with a touch-screen controller 140. The touch-screen controller 140 is connected through the electrical buss connections 136 and wires 134 outside the display area 111 to control the touch screen 120. The touch-screen controller 140 detects touches on the touch screen 120 by sequentially electrically energizing and testing the first and the second transparent electrodes 130, 132.

Referring to FIG. 11, in another prior-art embodiment, the rectangular first and second transparent electrodes 130, 132 are arranged orthogonally in the display area 111 over the display 110 on the first and second transparent substrates 122, 126 with the intervening transparent dielectric layer 124, forming the touch screen 120 which, in combination with the display 110 forms the touch screen and display system 100. The first and second pad areas 128, 129 are formed where the first and second transparent electrodes 130, 132 overlap. The touch screen 120 and the display 110 are controlled by the touch screen and display controllers 140, 142, respectively, through the electrical busses 136 and wires 134 outside the display area 111.

The electrical busses 136 and wires 134 are electrically connected to the first or second transparent electrodes 130, 132 but are located outside the display area 111. However, at least a portion of the electrical busses 136 or wires 134 are formed on the touch screen 120 to provide the electrical connection to the first or second transparent electrode 130, 132. It is desirable to maximize the size of the display area 111 with respect to the entire display 110 and the touch screen 120. Thus, it is helpful to reduce the size of the wires 134 and electrical busses 136 in the touch screen 120 outside the display area 111. At the same time, to provide excellent electrical performance, the wires 134 and electrical busses 136 need a low resistance. Furthermore, to reduce manufacturing costs, it is desirable to reduce the number of manufacturing steps and materials in touch screen 120.

Touch-screens including very fine patterns of conductive elements, such as metal wires or conductive traces are known. For example, U.S. Patent Application Publication No. 2010/0026664 teaches a capacitive touch screen with a mesh electrode, as does U.S. Pat. No. 8,179,381. Referring to FIG. 12, the prior-art x-dimension X or y-dimension Y variable-width first or second transparent electrode 130, 132 includes a micro-pattern 156 of micro-wires 150 arranged in a rectangular grid. The micro-wires 150 are multiple, very thin metal conductive traces or wires formed on the first and second transparent substrates 122, 126 (FIG. 9) to form the x- or y-dimension X, Y first or second transparent electrodes 130, 132. The micro-wires 150 are so narrow that they are not readily visible to an unaided human observer, for example 1 to 10 microns wide. The micro-wires 150 are typically opaque and spaced apart, for example by 50 to 500 microns, so that the first or second transparent electrodes 130, 132 appear to be transparent and the micro-wires 150 are not distinguished by an observer.

U.S. Patent Application Publication No. 2011/0291966 discloses an array of diamond-shaped micro-wire structures. In this disclosure, a first electrode includes a plurality of first conductor lines inclined at a predetermined angle in clockwise and counterclockwise directions with respect to a first direction and provided at a predetermined interval to form a grid-shaped pattern. A second electrode includes a plurality of second conductor lines, inclined at the predetermined angle in clockwise and counterclockwise directions with respect to a second direction, the second direction perpendicular to the first direction and provided at the predetermined interval to form a grid-shaped pattern. This arrangement is used to inhibit Moiré patterns. The electrodes are used in a touch-screen device. Referring to FIG. 13, this prior-art design includes micro-wires 150 arranged in a micro-pattern 156 with the micro-wires 150 oriented at an angle to the direction of horizontal first transparent electrodes 130 in a first layer (e.g. first transparent substrate 122 in FIG. 11) and vertical second transparent electrodes 132 in a second layer (e.g. second transparent substrate 126 in FIG. 11).

A variety of layout patterns are known for micro-wires used in transparent electrodes. U.S. Patent Application Publication No. 2012/0031746 discloses a number of micro-wire electrode patterns, including regular and irregular arrangements. The conductive pattern of micro-wires in a touch screen can be formed by closed figures distributed continuously in an area of 30% or more, preferably 70% or more, and more preferably 90% or more of an overall area of the substrate and can have a shape where a ratio of standard deviation for an average value of areas of the closed figures (a ratio of area distribution) can be 2% or more. As a result, a Moiré phenomenon can be prevented and excellent electric conductivity and optical properties can be satisfied. U.S. Patent Application Publication No. 2012/0162116 discloses a variety of micro-wire patterns configured to reduce interference patterns. As illustrated in FIG. 14, U.S. Patent Application Publication No. 2011/0007011 teaches the first or second transparent micro-wire electrode 130, 132 having micro-wires 150 arranged in a micro-wire pattern 156.

Touch-screen sensors are also used to detect fingerprints. For example, U.S. Pat. No. 5,325,442 discloses a fingerprint sensing device and a recognition system having a row/column array of sense elements coupled to drive and sense circuits. U.S. Pat. No. 6,016,355 and U.S. Pat. No. 6,429,666 disclose capacitive fingerprint acquisition sensors. U.S. Pat. 7,099,496 teaches a swiped aperture capacitive fingerprint sensing system. U.S. patent application Ser. No. 12/914,812 discloses an integrated fingerprint sensor and display. In general, the fingerprint sensors use a higher spatial frequency of conductive lines operated with a higher temporal frequency of electromagnetic signals to detect fingerprints than are used for touch screens that only detect touches. Signature sensors are also known. In known prior-art touch screen designs, electrodes have a width of 5 mm and can include micro-wires having a width of 5 microns at a spacing of 100 microns. Signature sensors can use micro-wires with a 317 micron pitch and fingerprint sensor can use micro-wires with a 50-100 micron pitch. It is difficult or expensive to make and interconnect transparent electrodes for touch screens having the greater resolutions useful for signature and fingerprint sensing applications and the size required for some touch screens. Furthermore, an increased spatial density of lines reduces the transparency of such a touch device and increases manufacturing costs.

Micro-wire electrodes enable a variety of functions and applications. There is a need, therefore, for improved electrically conductive micro-wire structures and electrodes that provide improved conductivity, sensitivity, spatial resolution, size, and optical uniformity.

### SUMMARY OF THE INVENTION

In accordance with the present invention, a method of operating a micro-wire electrode structure having first micro-wire electrodes providing a first spatial electrode resolution and second micro-wire electrodes providing a second spatial electrode resolution greater than the first spatial electrode resolution to detect first and second spatial electrode resolution signals comprises:
using a controller to receive an electrical signal from one or more first electrodes having visually uniform micro-wires arranged on a surface in a surface area, each first electrode including two or more electrically connected micro-wires in the surface area providing the first spatial electrode resolution; and
using the controller to receive an electrical signal from one or more second electrodes having visually uniform micro-wires arranged on the surface in the surface area, each second electrode including one or more electrically connected micro-wires in the surface area providing the second spatial electrode resolution greater than the first spatial electrode resolution, wherein the second electrodes have a smaller electrode area and a smaller micro-wire area than the first electrodes in the surface area and the first and second electrode areas are visually uniform; and
detecting the first spatial-resolution signal from the first electrode(s) and detecting the second spatial-resolution signal from the second electrode(s).

According to embodiments of the present invention, electrically conductive micro-wire structures and electrodes provide improved conductivity, sensitivity, optical uniformity, size, and high-density spatial resolution. In various embodiments, such micro-wire arrangements are useful for touch detection, signature recognition, or fingerprint sensing or combinations of touch detection, signature recognition, or fingerprint sensing in a common sensing device.

### BRIEF DESCRIPTION OF THE DRAWINGS

The above and other features and advantages of the present invention will become more apparent when taken in conjunction with the following description and drawings wherein identical reference numerals have been used to designate identical features that are common to the figures, and wherein:

FIG. 1A is a plan view of a one-dimensional embodiment of the present invention;

FIG. 1B is a partial cross section of an embodiment of the present invention illustrated in FIG. 1A;

FIG. 2A is a plan view of a two-dimensional embodiment of the present invention;

FIG. 2B is a partial cross section of an alternative embodiment of the present invention;

FIG. 3 is a plan view of an alternative one-dimensional embodiment of the present invention;

FIGS. 4-6 are detail plan views of high-spatial-resolution portions of an embodiment of the present invention;

FIG. 7 is a schematic of a system embodiment of the present invention;

FIG. 8 is a flow diagram illustrating a method of the present invention;

FIG. 9 is a perspective of a prior-art display and touch-screen system;

FIG. 10 is a plan view of a prior-art display and touch-screen system;

FIG. 11 is a perspective of a prior-art display and micro-wire touch-screen system;

FIG. 12 is a schematic illustrating a prior-art micro-wire electrode;

FIG. 13 is a schematic illustrating overlapping orthogonal prior-art micro-wire electrodes;

FIG. 14 is a schematic illustrating a prior-art micro-wire pattern;

FIGS. 15 and 16 are a flow diagrams illustrating methods of the present invention; and

FIG. 17 is a plan view of an embodiment of the present invention.

The Figures are not necessarily to scale, since the range of dimensions in the drawings is too great to permit depiction to scale.

### DETAILED DESCRIPTION OF THE INVENTION

According to embodiments of the present invention, touch screens with micro-wire electrodes can provide optical uniformity and regions of high-spatial-resolution scanning. At least one electrode has a different electrode area and a different micro-wire area than another electrode. The electrodes can each have a constant width or a rectangular shape. Conventional touch screens are limited in the spatial density of their scanning by the number of electrodes and their controller connections. In designs of the present invention using micro-wire electrodes, by adding extra electrodes (but not extra micro-wires), higher-resolution scanning is accomplished in a portion of the touch screen with optical uniformity and a limited increase in electrode controller connections.

In embodiments of the present invention, the spacing of micro-wires on a substrate is constant but the number of micro-wires in a micro-wire electrode and the spatial density of micro-wire electrodes is different in different micro-wire electrodes so that some micro-wire electrodes with more micro-wires occupy a larger surface area of a substrate and other micro-wire electrodes with fewer micro-wires occupy a smaller surface area of the substrate. Such micro-wire electrode arrangements are useful for capacitive touch sensing, signature recognition, and finger-print scanning in a common device with a visually uniform arrangement of micro-wires suitable for use in conjunction with a display. Visual uniformity is important in a display because any non-uniformity tends to be visible and distracts from or inhibits the content shown on the display.

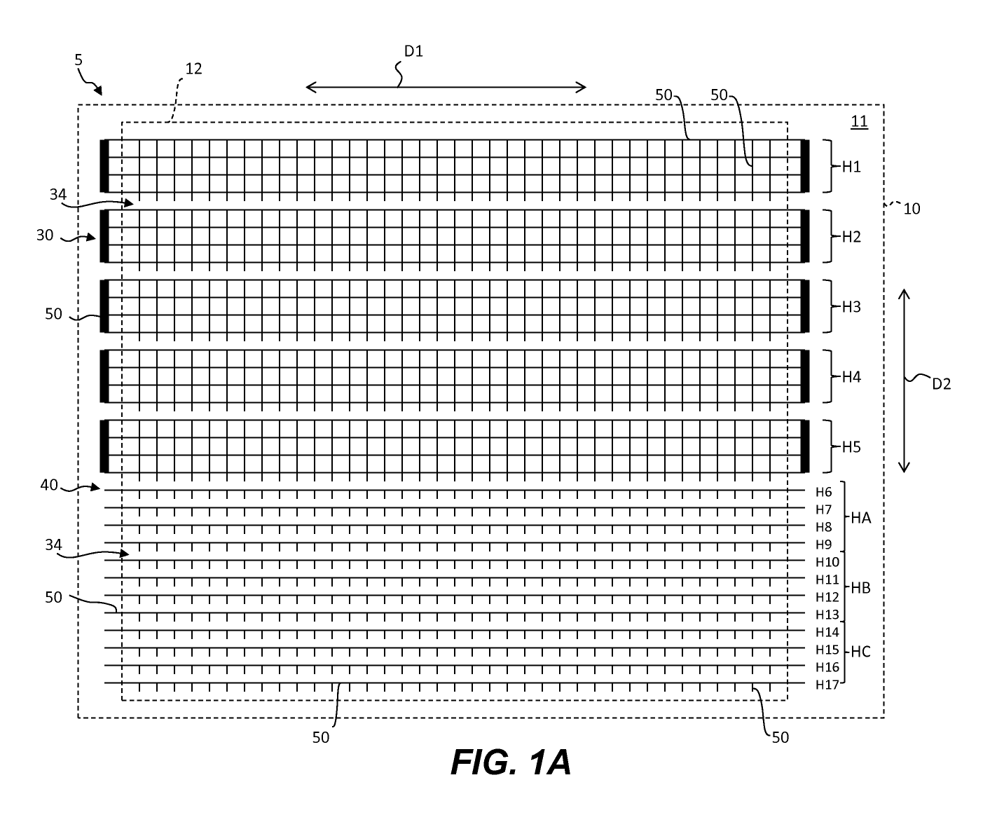

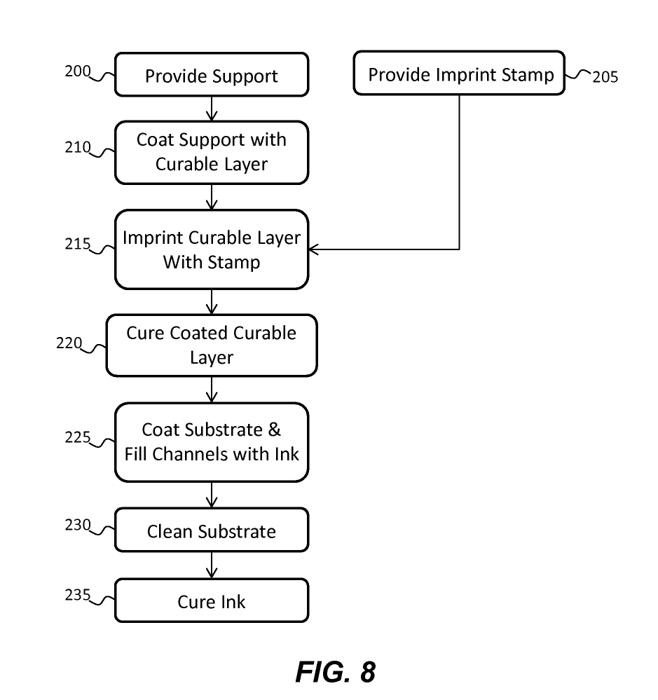

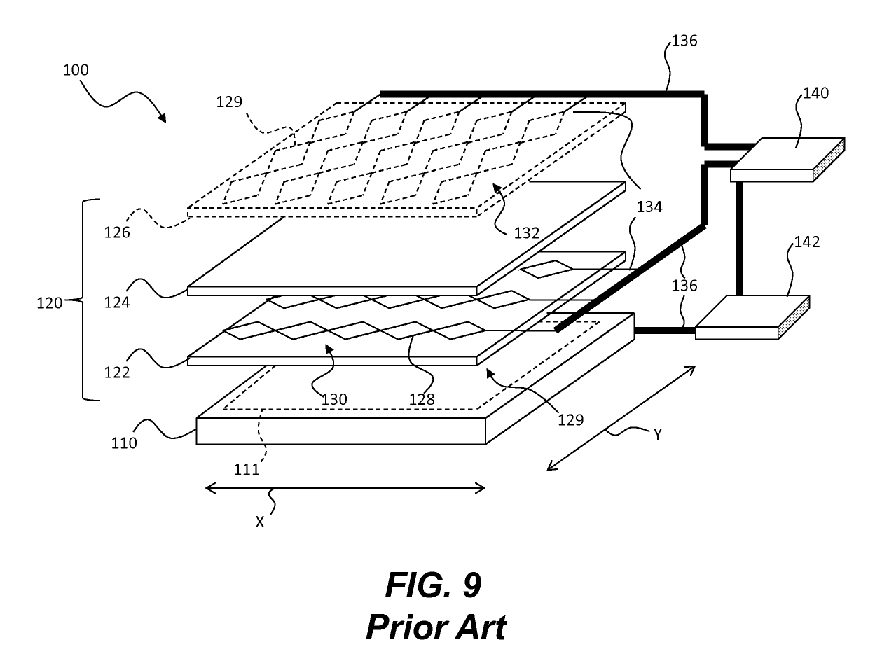

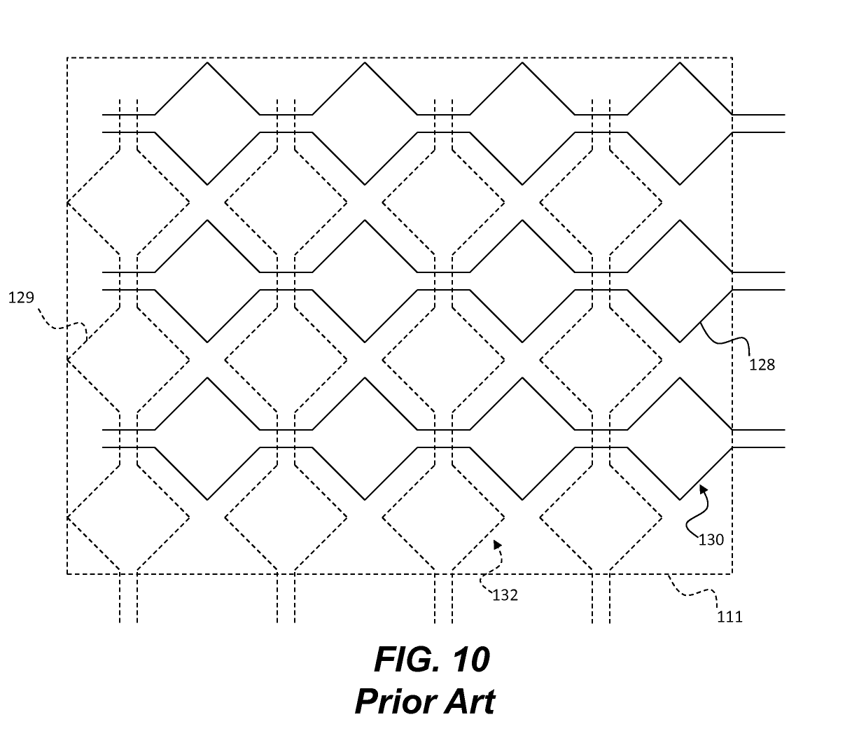

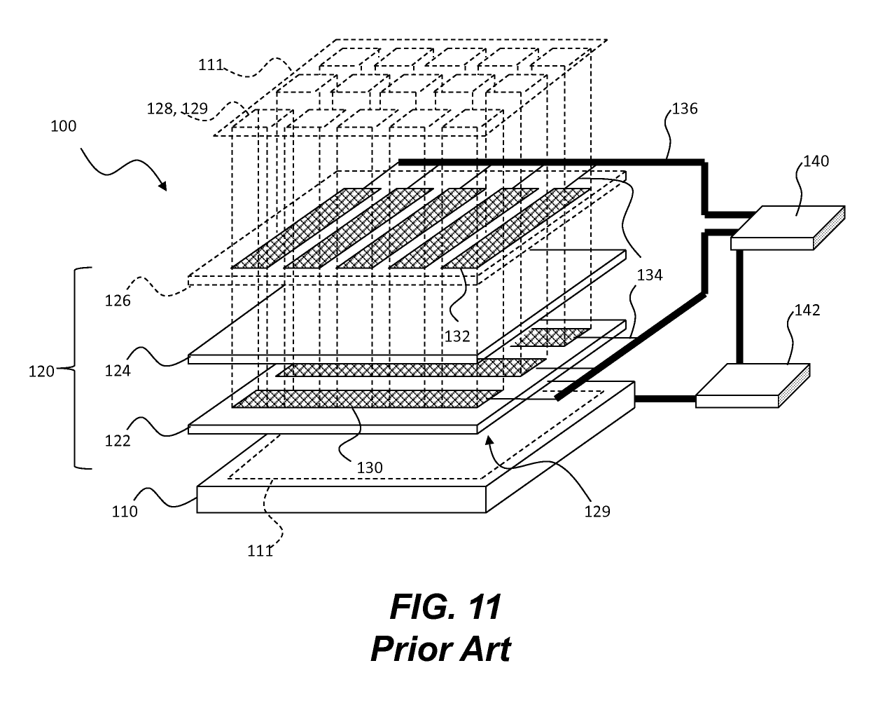

Referring to FIG. 1A, in an embodiment of the micro-wire electrode structure 5 of the present invention, a substrate 10 having a surface 11 with a surface area 12 that includes a visually uniform arrangement of micro-wires 50 is formed in relation to the surface 11, for example on the surface 11 or extending from the surface 11 into the substrate 10. As used herein, visually uniform also refers to visually uniform to the unaided human visual system or visually uniform. The surface area 12 is a portion of the surface 11 of the substrate 10, for example a display area corresponding to a display (not shown, see display area 111 of FIG. 9) or an interactive area such as a touch-interactive area. In an embodiment, the surface area 12 is rectangular; alternatively the surface area 12 includes contiguous rectangular portions, has straight edges, or has curved edges. One or more first electrodes 30 each include two or more electrically connected micro-wires 50 in the surface area 12 providing a first spatial electrode resolution. One or more second electrodes 40 each include one or more electrically connected micro-wires 50 in the surface area 12 providing a second spatial electrode resolution greater than the first spatial electrode resolution. The second electrodes 40 have a smaller electrode area and a smaller micro-wire area than the first electrodes 30 in the surface area 12. The areas of the first and second electrodes 30, 40 are visually uniform. In an embodiment, the micro-wires 50 of the first electrodes 30 and the micro-wires 50 of the second electrodes 40 are formed in a common layer on the substrate 10 surface 11 or extending into the substrate 10 from the surface 11. In another embodiment, the micro-wires 50 of the first electrodes 30 are adjacent to each other or the micro-wires 50 of the second electrodes 40 are adjacent to each other within the common layer.

The electrode area of the first electrode 30 is the area of a convex hull enclosing all of the micro-wires 50 in the first electrode 30 in the surface area 12. Likewise, the electrode area of the second electrode 40 is the area of a convex hull enclosing all of the micro-wires 50 in the second electrode 40 in the surface area 12. The micro-wire area of an electrode is the total area of the micro-wires 50 in the electrode in the surface area 12. The spatial density of the micro-wires 50 in the first and second electrodes 30, 40 is the same, so as to provide optical uniformity; however, since the area of the second electrodes 40 is smaller than the area of the first electrodes 30, the area of the micro-wires 50 within the second electrodes 40 is likewise smaller than the area of the micro-wires 50 within the first electrodes 30.

As shown in FIG. 1A, the first electrodes 30 are arranged horizontally and have four micro-wires 50 each extending in the direction D1. Additional connecting micro-wires 50 extend in a direction D2 different from D1 and are positioned at the ends of the first electrodes 30 and at other locations in the first electrodes 30 to provide redundant electrical interconnections between the micro-wires 50 in the first electrode 30. In the example of FIG. 1A, the second electrodes 40 include only a single micro-wire 50 extending in the direction D1 and others extending in the direction D2. In alternative embodiments, the second electrodes 40 include two or more micro-wires 50 extending in the direction D1 and others extending in the direction D2 or in directions other than D1 or D2. The first electrodes 30 are labeled H1, H2, H3, H4, and H5. The second electrodes 40 are labeled H6-H17.

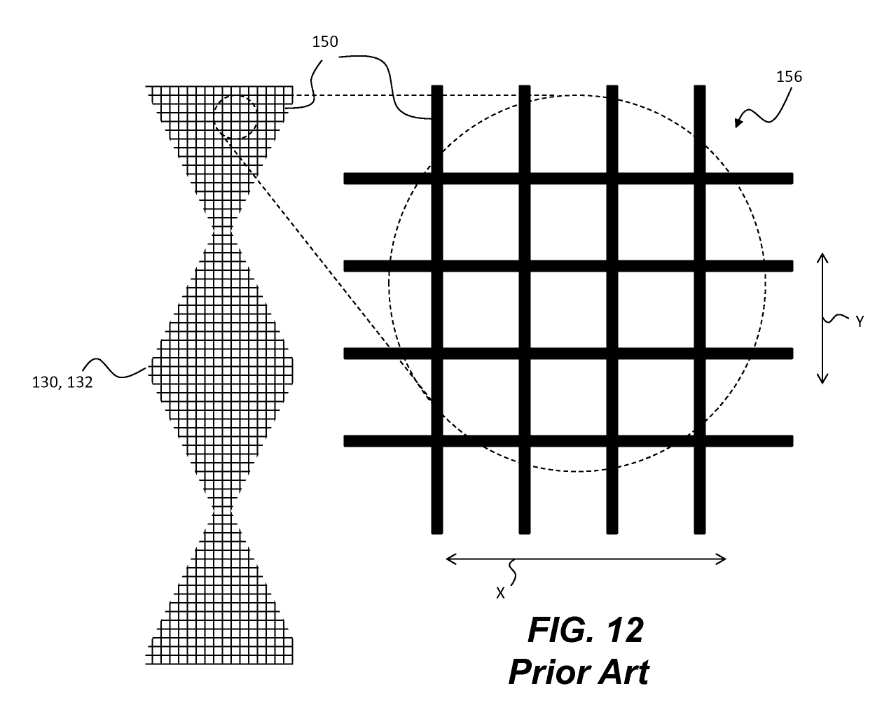

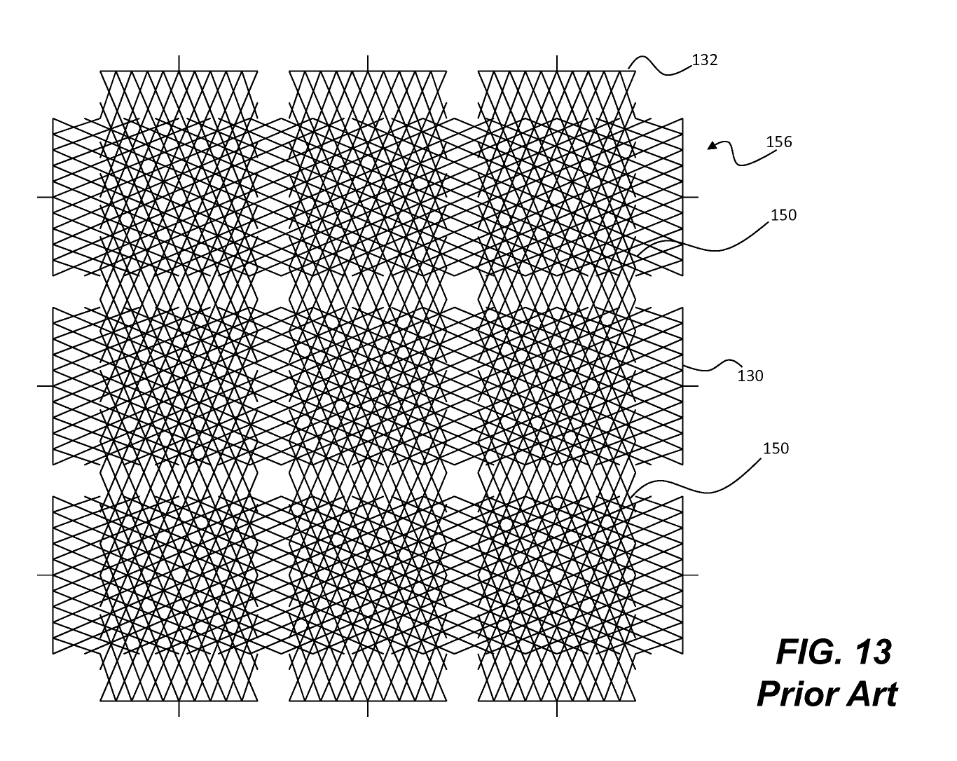

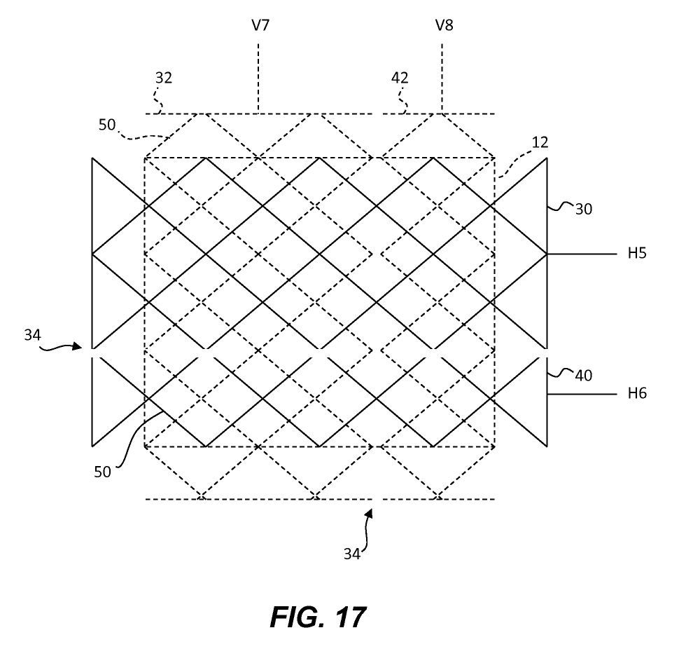

Although some of the micro-wires 50 are illustrated as straight horizontal micro-wires 50 that extend in the same direction D1 as the first electrode 30 or the second electrode 40, in other embodiments the micro-wires 50 are not straight or do not extend parallel to the direction D1 of the first electrode 30 (for example as illustrated in the electrodes and micro-wires of FIG. 13 and FIG. 17, described below).

As intended herein, two electrodes are adjacent if there is no other electrode between the two electrodes in the same layer as the two electrodes. For example, the first electrode H1 is adjacent to the first electrode H2 because there is no other first electrode 30, or any other electrode, between the first electrodes H1 and H2. Similarly, for example, the second electrode H7 is adjacent to the second electrode H8 because there is no other second electrode 40 or any other electrode between the second electrodes H7 and H8.

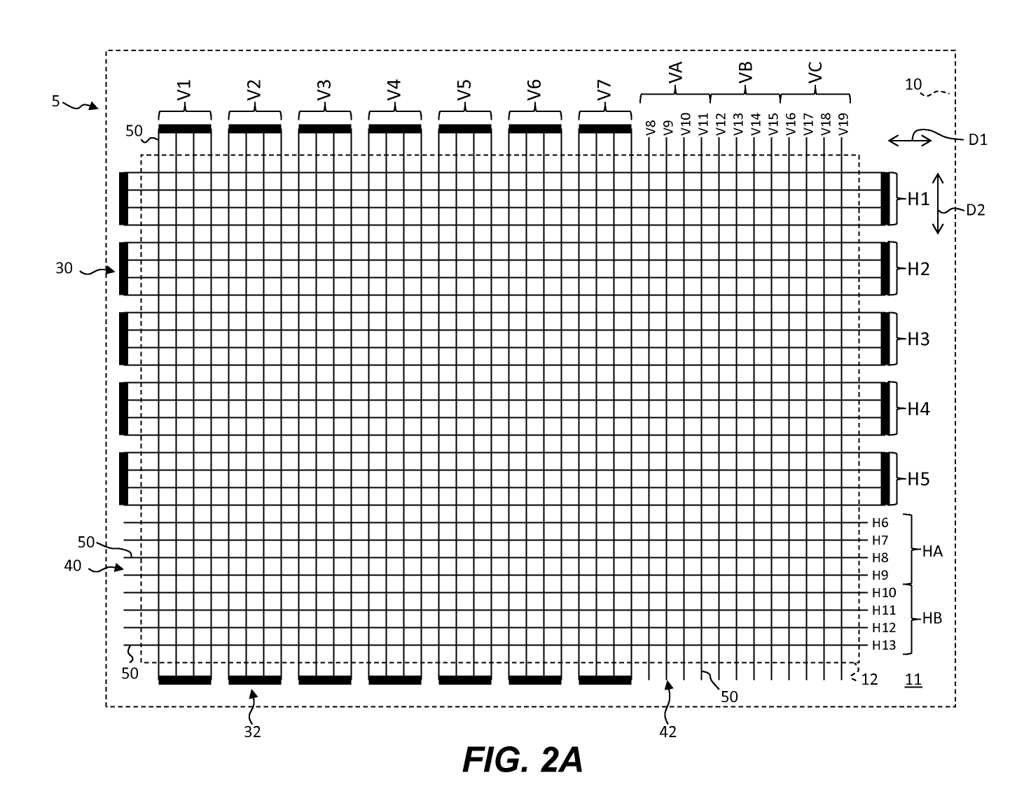

As illustrated in FIG. 1A (and below in FIGS. 3 and 17), small gaps 34 are shown between the micro-wires 50 of the different first and second electrodes 30, 40. These gaps 34 prevent adjacent electrodes from electrically shorting together. In practical embodiments, the gaps 34 are very small and are not readily visible to the unaided human visual system, for example a few microns in width. The gaps 34 are visibly illustrated in FIG. 1A to clarify that each of the different first and second electrodes 30, 40 is electrically distinct. In an embodiment, the gaps 34 are ignored in calculations of the electrode area or the micro-wire area.

The micro-wires 50 are arranged in a visually uniform arrangement in the surface area 12 and within the areas of the first and second electrodes 30, 40. A visually uniform arrangement is one in which the arrangement of micro-wires 50 appear uniformly arranged to the unaided human visual system or visually appears to have a uniform optical density. Visually uniform micro-wires 50 are micro-wires 50 that are arranged in the surface area 12 in such a way that the micro-wires 50 appear to be uniformly distributed and provide an apparently uniform optical density in an electrode area or in the surface area 12. In an embodiment, the micro-wires 50 have a width of less than 20 microns, 10 microns, 5 microns, 2 microns, or 1 micron and are not readily visible to the unaided human eye and are spaced apart by distances of 100 microns, 200 microns, 500 microns, 1000 microns or 2000 microns. In an embodiment, the gaps 34 are ignored with respect to the present invention when considering optical or visual uniformity, since the gaps 34 are so small as to be practically invisible to the unaided human visual system and so that the gaps 34 are excluded from the area of the first and second electrodes 30, 40. According to an embodiment of the present invention, the optical uniformity of the micro-wires 50 refers to optical uniformity within the areas of the first and second electrodes 30, 40. Thus, in an embodiment, the surface area 12 with the visually uniform arrangement of micro-wires 50 has a visually uniform optical density.

As shown in FIG. 1A and also in the cross section of FIG. 1B, the first electrodes 30 are arranged together in a portion of the surface area 12 of surface 11 and extending into the substrate 10 from the surface 11 so that the first electrodes 30 are adjacent to each other. Likewise, the second electrodes 40 are arranged together in a different portion of the surface area 12 of surface 11 and extending into the substrate 10 from the surface 11 so that the second electrodes 40 are adjacent to each other. As shown in the plan view of FIG. 1A, the first electrodes 30 (labeled H1, H2, H3, H4, H5) are located together in the upper portion or side of the surface area 12 and the second electrodes 40 (labeled H6-H17) are located together in the lower portion or side of the surface area 12. As shown in the cross section of FIG. 1B, the surface area 12 of the substrate 10 including the micro-wires 50 having a common width W are spatially distributed in a regular arrangement with a constant separation S providing a visually uniform distribution of micro-wires 50. The leftmost micro-wires 50 of FIG. 1B correspond to the first electrode 30 labeled H5 in FIG. 1A and the right-most micro-wires 50 of FIG. 1B correspond to the second electrodes 40 labeled H6, H7, and H8 in FIG. 1A.

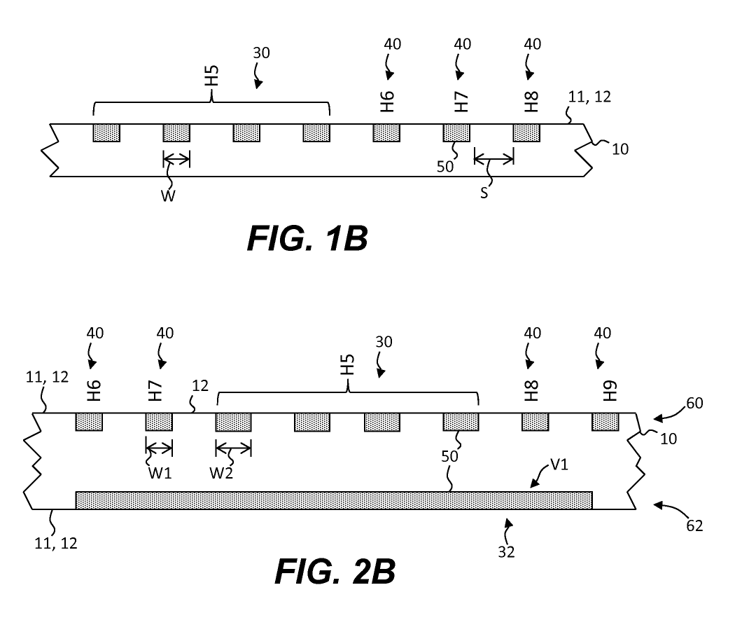

As illustrated in FIGS. 1A and 1B, the first and second electrodes 30, 40 extend primarily in direction D1 and in a single layer. Referring to the plan view of FIG. 2A and the cross section of FIG. 2B, in an alternative embodiment of the present invention, a two-dimensional arrangement of micro-wires 50 forms micro-wire electrodes in two layers that extend in orthogonal directions D1 and D2. As shown in FIG. 2A, a micro-wire electrode structure 5 includes substrate 10 having a surface 11 with a surface area 12. A visually uniform arrangement of micro-wires 50 is formed in relation to the surface 11 on one side of the substrate 10. One or more first electrodes 30 each include two or more electrically connected micro-wires 50 and one or more second electrodes 40 each include two or more electrically connected micro-wires 50. The second electrodes 40 have a smaller electrode area and a smaller micro-wire area than the first electrodes 30 in the surface area 12 and the areas of the first and second electrodes 30, 40 are visually uniform. The first electrodes 30 are labeled H1-H5 and the second electrodes 40 are labeled H6-H13.

A second visually uniform arrangement of micro-wires 50 is formed in relation to the surface 11 on a side of the substrate 10 opposing the micro-wires 50 of the first and second electrodes 30, 40. One or more electrically isolated third electrodes 32 each include two or more electrically connected micro-wires 50 and one or more electrically isolated fourth electrodes 42 each include one or more electrically connected micro-wires 50. The fourth electrodes 42 have a smaller electrode area and a smaller micro-wire area than the third electrodes 32 in the surface area 12 and the areas of the third and fourth electrodes 32, 42 are visually uniform. The third electrodes 32 are labeled V1-V7 and the fourth electrodes 42 are labeled V8-V19. Note that because the plan view of FIG. 2A includes the micro-wires 50 of both horizontal and vertical electrodes, the gaps 34 of FIG. 1A in the micro-wires 50 are not visible in the plan view of FIG. 2A. Nonetheless, the gaps 34 in the micro-wires 50 are present in the embodiment of FIG. 2A and serve to electrically isolate adjacent electrodes in both the horizontal and vertical directions D1, D2 and provide optical and visual uniformity.

In an embodiment of the micro-wire electrode structure 5 of the present invention, the first electrodes 30 and the second electrodes 40 extend in a first direction D1, the third electrodes 32 and fourth electrodes 42 extend in a second direction D2, and the first direction D1 is different from the second direction D2, for example the first direction D1 is orthogonal to the second direction D2. In another embodiment, the micro-wires 50 of the third electrodes 32 have the same pattern as or are a rotated version of the micro-wires 50 of the first electrodes 30 and the fourth electrodes 42 have the same micro-wire patterns as or are a rotated version of the pattern of micro-wires 50 of second electrodes 40. The first and second electrodes 30, 40 can have the same apparent optical density as the third and fourth electrodes 32, 42. In an embodiment, the first, second, third, and fourth electrodes 30, 40, 32, 42 are visually or optically uniform in combination. In yet another embodiment, the micro-wires 50 of the third and fourth electrodes 32, 42 have the same micro-wire pattern as the micro-wires 50 of the first and second electrodes 30, 40 and are spatially arranged 180 degrees out of phase with the micro-wires 50 of the first and second electrodes 30, 40. Alternatively, the third and fourth electrodes 32, 42 have the same micro-wire pattern as the micro-wires 50 of the first and second electrodes 30, 40 and are spatially arranged in phase with the first and second electrodes 30, 40.

Referring also to the embodiment illustrated in the partial cross section of FIG. 2B, the first electrodes 30 and second electrodes 40 are formed in a first common layer 60 on or in the surface 11 of the substrate 10 in the surface area 12 and the third electrodes 32 and fourth electrodes 42 (FIG. 2A, not shown on FIG. 2B) are formed in a second common layer on or in an opposing surface 11 in the surface area 12. The first common layer 60 is different from the second common layer 62. As shown in FIG. 2B, the electrodes have micro-wires 50 formed on or in the surface area 12 of each of two opposing sides or surfaces 11 of substrate 10. The micro-wires 50 on one side forming first electrodes 30 (H5) and second electrodes 40 (H6-H9) are formed in a first common layer 60 and the micro-wires 50 on the other side forming third electrodes 32 (V1) and fourth electrodes 42 (not shown) are formed in a second common layer 62. As shown in FIG. 2B, in contrast to FIG. 2A, the first electrodes 30 and the second electrodes 40 are interdigitated. Furthermore, as shown in FIG. 2B, the micro-wires 50 include micro-wires 50 having a first width W1 and micro-wires 50 having a second width W2 different from the first width W1. As also shown, the width W2 of the micro-wires 50 in the first electrode 30 is different from the width W1 of the micro-wire(s) 50 in the second electrodes 40.

FIG. 17 is a plan view of a portion of a two-dimensional electrode structure according to an embodiment of the present invention. As shown in FIG. 17, one first electrode 30 and one second electrode 40 adjacent to the one first electrode 30 are separated by a gap 34 and extend horizontally across the surface area 12. One third electrode 32 and one fourth electrode 42 adjacent to the one third electrode 32 are separated by a gap 34 and extend vertically across the surface area 12. Each of the first, second, third, and fourth electrodes 30, 40, 32, 42 include diagonal micro-wires 50 that form diamond shapes. The micro-wires 50 of the first and second electrodes 30, 40 (labeled as H5 and H6 in correspondence to FIG. 2A) are in a first layer (not indicated but corresponding to the first common layer 60 in FIG. 2B) and the micro-wires 50 of the third and fourth electrodes 32, 42 (labeled as V7 and V8 in correspondence to FIG. 2A) are in a second layer (not indicated but corresponding to the second common layer 62 in FIG. 2B). The micro-wires 50 of the first and second electrodes 30, 40 have the same patterns as the micro-wires 50 of the third and fourth electrodes 32, 42 but are spatially out of phase by 180 degrees in one dimension. Thus, the first, second, third, and fourth electrodes 30, 40, 32, 42 are visually uniform as is the combination of the first, second, third, and fourth electrodes 30, 40, 32, 42 in the surface area 12, ignoring the gaps 34.

As shown in FIGS. 1A and 2A, the first and second electrodes 30, 40 extend across the surface area 12. In an alternative embodiment, referring to FIG. 3, at least some of the first or second electrodes 30,40 extend only partway across the surface area 12 of the substrate 10. Thus, in an embodiment the second electrodes 40 having a higher spatial density (electrodes H6-H17) can include only a portion of the surface area 12, for example a corner of the lower portion of the surface area 12, as shown. The micro-wires 50 in the lower portion of the surface area 12 that is not in the corner (electrodes HA, HB, HC) are electrically connected as first electrodes 30. Thus some of the first electrodes 30 extend across the surface area 12 and others do not and the second electrodes 40, in this configuration, do not extend across the surface area 12.

In a further embodiment of the invention, not specifically shown in FIG. 3, third and fourth electrodes 32, 42 extend vertically (as in FIG. 2A). A portion of the third and fourth electrodes 32, 42 extend only partway across the surface area 12, so that the corner of the surface area 12 includes both the second electrodes 40 and the fourth electrodes 42.

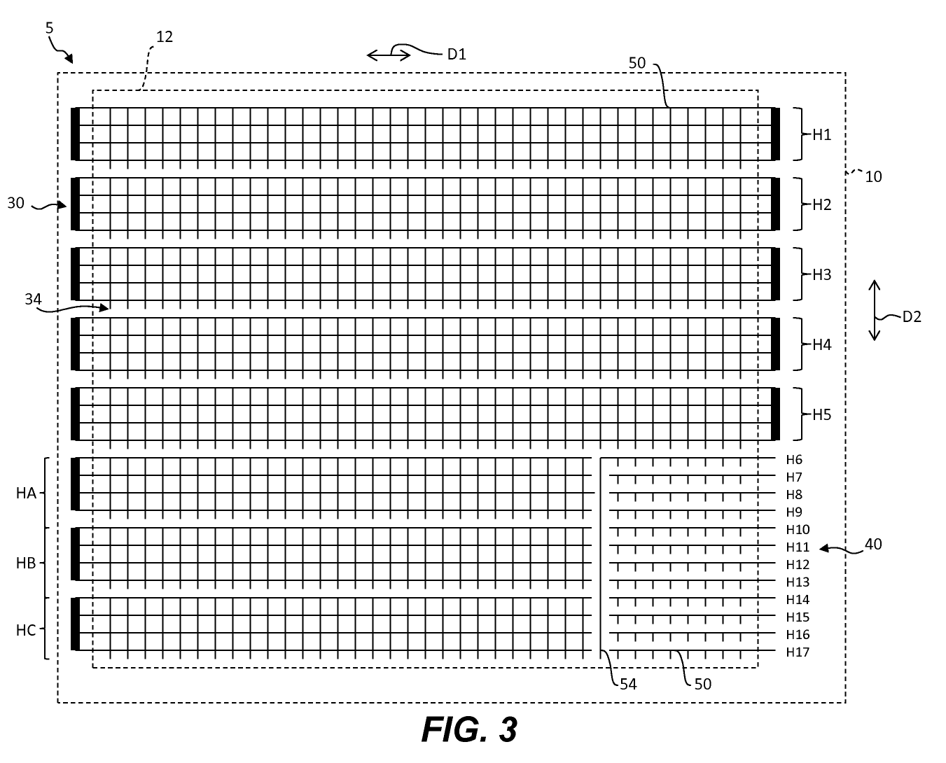

As also shown in FIG. 3, the second electrode 40 labeled H6 includes an angled micro-wire 54 extending partially in direction D2 different from and orthogonal to direction D1 in which the first electrodes 30 extend or the second electrodes 40 not including the angled micro-wire 54 extend. The angled micro-wire 54 is adjacent to one or more second electrodes 40 (e.g. electrodes labeled H7-H17). In an alternative embodiment, referring to FIG. 4, the angled micro-wire 54 extends in a direction different from D1 but not orthogonal to D1. The gaps 34 separate the angled micro-wire 54 from the first and second electrodes 30, 40. In FIG. 4, first electrodes 30 labeled HA, HB, HC are in a visually uniform horizontal arrangement with the second electrodes 40 labeled H6-H17 made up on micro-wires 50.

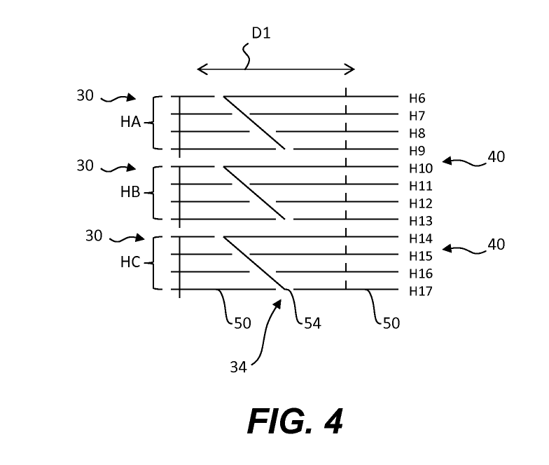

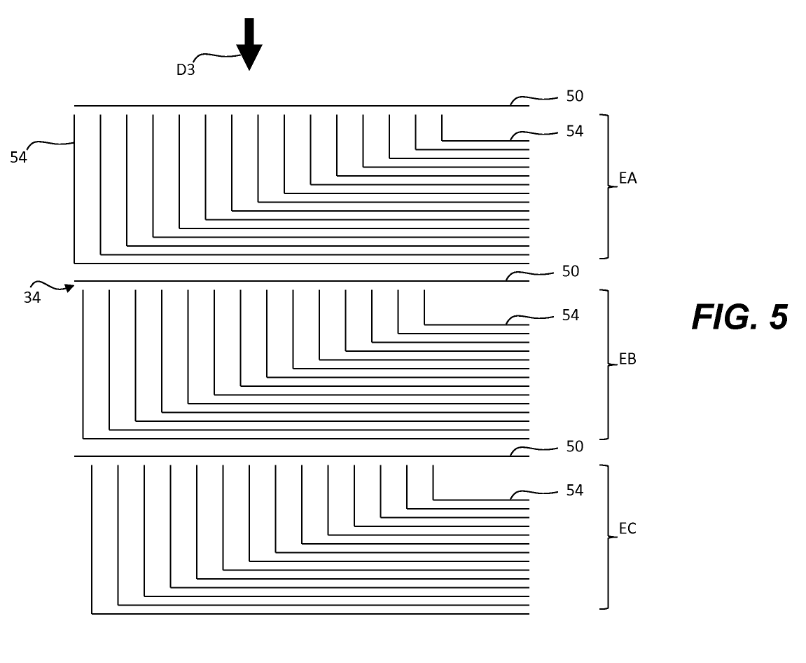

Referring next to FIG. 5, multiple angled micro-wires 54 are provided and arranged in groups (EA, EB, and EC) interdigitated with non-angled micro-wires 50. FIG. 6 illustrates an embodiment in which, multiple angled micro-wires 54 are provided and arranged in groups (EA, EB) on either side of the non-angled micro-wire 50. The gaps 34 separate the angled micro-wire 54 from the first and second electrodes 30, 40. The angled micro-wires 54 in the group EA are horizontally offset with respect to the angled micro-wires 54 in the group EB. The angled micro-wires 54 in the group EB are horizontally spatially offset with respect to the angled micro-wires 54 in the group EC (FIG. 5). Thus a measurement of an object structure that moves in the direction D3 (or the reverse direction) obtained from the combined electrical signals of each of the electrode groups EA, EB, and EC will indicate the structure of the object at a resolution higher than the resolution of any of the individual groups EA, EB, or EC.

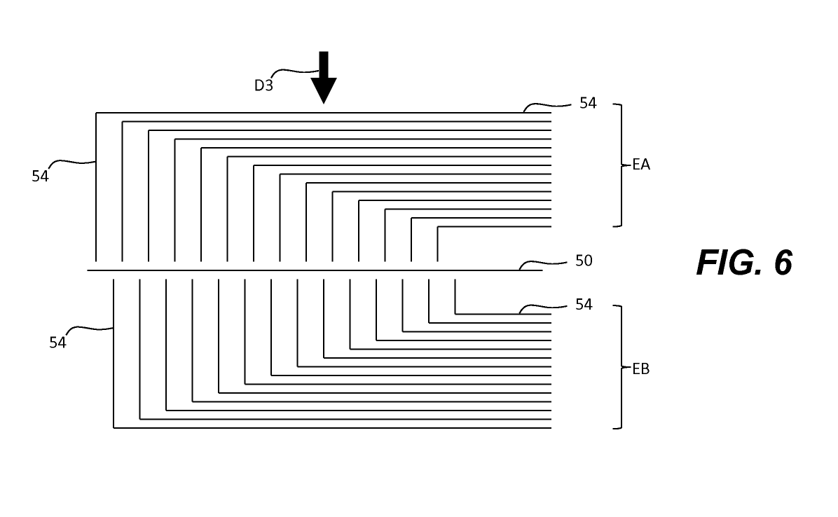

As shown in FIG. 7, a micro-wire electrode structure 5 includes a surface 11 of a substrate 10 having a surface area 12. A visually uniform arrangement of micro-wires 50 is formed in relation to the surface 11. One or more first electrodes 30 include two or more electrically connected micro-wires 50. One or more second electrodes 40 include one or more electrically connected micro-wires 50, where the second electrodes 40 have a smaller electrode area and a smaller micro-wire area than the first electrodes 30 in the surface area 12. The areas of the first and second electrodes 30, 40 are visually uniform. A controller 70 is connected to the first electrode(s) 30 and to the second electrode(s) 40. The first and second electrodes 30, 40 are connected by electrical connections 80, for example in a bus 82, to the controller 70. In one embodiment, the controller 70 includes a first control circuit 72 connected to the first electrodes 30 and a second control circuit 74 connected to the second electrode(s) 40. In another embodiment, the controller 70 includes a switching circuit 78 for electrically connecting or combining two or more of the second electrodes 40 together and connecting the two or more electrically connected or combined second electrodes 40 to the first control circuit 72. In yet another embodiment, the controller 70 includes a selection circuit 76 for selecting a subset of the first and second electrodes 30, 40 and connecting the selected subset to the first or second circuits 72, 74. Thus, a single circuit is useful to sequentially process electrical signals from each of the first or second electrodes 30, 40 or combined electrical signals from the second electrodes 40.

In an embodiment of the present invention illustrated in FIG. 2A, the first and third electrodes 30, 32 form orthogonal electrodes separated by a dielectric layer, for example the substrate 10. The orthogonal electrodes are used to implement a capacitive touch screen. At the same time, second and fourth electrodes 40, 42 form orthogonal electrodes separated by the dielectric layer and are also used to implement a capacitive touch screen, albeit at a higher spatial resolution. Capacitive touch screen controllers, and control, switching, and selection circuits are known in the art, for example using integrated circuits, and are useful with the present invention.

In a capacitive sensing device, both sense and drive electrodes are used. In one embodiment of the present invention, the density of electrodes in the sense electrodes is increased in a substrate surface area 12. In another embodiment, the density of electrodes in the drive electrodes is increased in a substrate surface area 12. In yet another embodiment, the density of electrodes in the drive electrodes and in the sense electrodes is increased in the same or different substrate surface areas 12 or portions of the surface area 12.

Electrodes having a variety of widths can provide spatial-resolution sensing at a corresponding variety of resolutions and can be useful for applications in which high-spatial-resolution detection is useful, for example fingerprint sensing, hand identification, or signature recognition integrated with conventional touch screen sensing. Spatial image processing for the high-resolution spatial signal can also support conventional touch screen sensing (e.g. with a low-pass filter, equivalent to shorting high-spatial frequency electrodes together). In a useful embodiment, different controllers with common high-impedance/tristate drivers are used for low-resolution electrical signal processing and high-resolution electrical signal processing.

In various embodiments, the electrodes are rectangular in shape and have a common length, although the widths of different electrodes are different. Each electrode can have a constant width across the surface area 12 rather than a variable width. Electrodes can extend across a sensing area such as surface area 12 or only partially across the sensing area. Sensing areas of the present invention can correspond to a display area 111 of a display 110, can correspond to a portion of a display area 111, or is larger than a display area 111. Sensing areas can also include user-interactive touch areas that are larger or smaller than a display area 111 or that extend beyond a display area 111.

In operation, apparently transparent micro-wire electrodes (e.g. first, second, third, and fourth electrodes 30, 40, 32, 42) are electrically connected to a controller 70, for example one or more integrated circuits such as hardware or software processors. In some embodiments, the integrated circuit processor is adhered to the same substrate 10 on or in which the electrodes are formed. In other embodiments a connector from the substrate 10 to the integrated circuit processor is needed. Integrated circuit processors useful for controlling apparently transparent micro-wire electrodes are known in the art and can be used with the present invention by providing electrical signals to the apparently transparent micro-wire electrodes or by measuring electrical signals from the apparently transparent micro-wire electrodes.

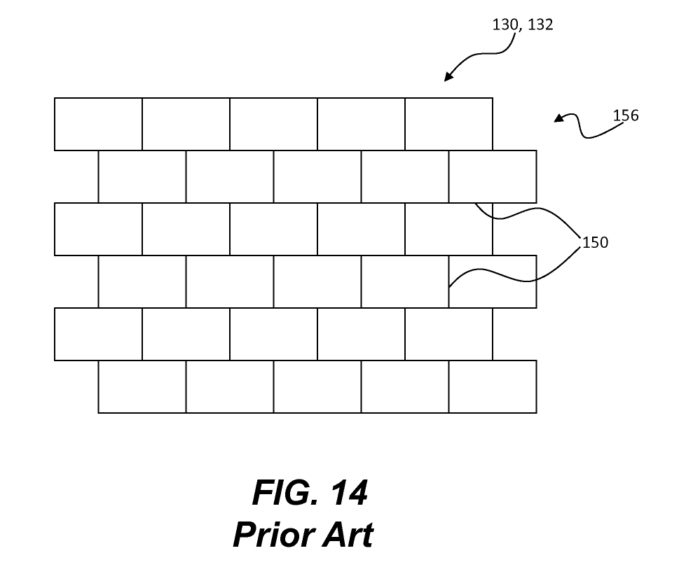

Referring to FIG. 15 and with reference to FIG. 7, in an embodiment of the present invention a method of operating the micro-wire electrode structure 5 includes using the controller 70 to receive an electrical signal from one or more of the first electrodes 30 in step 300. The first electrodes 30 have visually uniform micro-wires 50 arranged on a surface 11 in a surface area 12. Each first electrode 30 includes two or more electrically connected micro-wires 50 in the surface area 12 providing the first spatial electrode resolution. The method also includes using the controller 70 to receive an electrical signal from one or more second electrodes 40 having visually uniform micro-wires 50 arranged on the surface 11 in the surface area 12 in step 310. Each second electrode 40 includes one or more electrically connected micro-wires 50 in the surface area 12 providing the second spatial electrode resolution greater than the first spatial electrode resolution. The second electrodes 40 have a smaller electrode area and a smaller micro-wire area than the first electrodes 30 in the surface area 12. The areas of the first and second electrodes 30, 40 are visually uniform. Using the controller 70, or another processor, the received electrical signals are processed in step 320 to detect the first spatial-resolution signal from the first electrodes 30 and the second spatial-resolution signal from the second electrodes 40. The second spatial resolution signal has a resolution greater than the resolution of the first spatial resolution signal. Hence, the first spatial resolution signal is also referred to as a low-spatial-resolution signal and the second spatial resolution signal is also referred to as a high-spatial-resolution signal.

Referring further to FIG. 15 and additionally to FIG. 2A in another embodiment of the present invention, a method of operating the micro-wire electrode structure 5 further includes using the controller 70 in step 330 to provide an electrical signal to one or more of the third electrodes 32. The third electrodes 32 have visually uniform micro-wires 50 arranged on a surface 11 in a surface area 12. Each third electrode 32 includes two or more electrically connected micro-wires 50 in the surface area 12. The method also includes using the controller 70 in step 340 to provide an electrical signal to one or more fourth electrodes 42 having visually uniform micro-wires 50 arranged on the surface 11 in the surface area 12. Each fourth electrode 40 includes one or more electrically connected micro-wires 50 in the surface area 12. The fourth electrodes 42 have a smaller electrode area and a smaller micro-wire area than the third electrodes 32 in the surface area 12. The areas of the third and fourth electrodes 32, 42 are visually uniform. Thus, the electrical signals received from the first and second electrodes 30, 40 are stimulated by the electrical signals provided by the third and fourth electrodes 32, 42. As will be readily understood by those knowledgeable in the electronic arts, the designations of first, second, third, and fourth are arbitrary. Furthermore, the functions of the first and third electrodes 30, 32 can be interchanged, as can the functions of the second and fourth electrodes 40, 42 by the controller 70, by the electrical connections 80 to the controller 70, or by the switching circuit 78.

In an embodiment, the micro-wire electrode structure 5 of the present invention is used as a touch screen to detect the location of a physical signal such as a touch in the surface area 12. Because the spatial resolution of the second electrodes 40 is greater than the spatial resolution of the first electrodes 30, the spatial resolution of the touch location of the second electrodes 40 is greater than the spatial resolution of the touch location of the first electrodes 30. Thus the second electrodes 40 are useful to perform functions that are different from or require higher resolution than the functions performed by the first electrodes 30. For example, the second electrodes 40 can detect touches of a writing implement that writes signatures or draws graphic symbols at a relatively higher resolution than the first electrodes 30. Control methods for providing and receiving electrical signals used in capacitive touch screens for detecting locations, interpreting handwriting or drawing, or detecting structures are known in the art and are useful with the present invention. Low-spatial-resolution electrical signals are those received from the relatively low-resolution first electrodes 30 and high-spatial-resolution electrical signals are those received from the relatively high-resolution second electrodes 40.

In an embodiment, the touch screen has a relatively low-resolution area associated with the first electrodes 30 for conventional interaction with a touching implement to indicate a location and a relatively high-resolution area associated with the second electrodes 40 for detecting signatures, graphic elements, the outline of objects, or finger prints. Thus, in useful embodiments, a method of the present invention includes touching the surface area 12 at a location and using the controller 70 to determine the touch location, touching the surface area 12 at a multiple locations at different sequential times and using the controller 70 to determine the touch path (for example to detect a traced signature or graphic), touching the surface area 12 with an object having an outline and using the controller 70 to determine the outline or shape of an object, touching the surface area 12 with an object having a structure and using the controller 70 to determine the structure (for example a fingerprint), or touching the surface area 12 at a single location with different portions of the object at different sequential times and using the controller 70 to determine the structure (for example by swiping an object over a detection location). In various embodiments, the object is a finger, a hand, or a writing implement. As shown in FIGS. 3-6 in various embodiments of the present invention incorporating an angled micro-wire 54, by providing electrical signals to the micro-wires 50 of the second electrodes adjacent to the angled micro-wire 54, electrical signals detected by the angled micro-wires 54 in response to a series of touches by an object (for example by swiping an object over the angled micro-wire 54) can determine the structure of the object. FIG. 3 shows a single angled micro-wire 54, FIG. 4 shows multiple angled micro-wires 54, FIG. 5 illustrates a different arrangement of multiple angled micro-wires 54 and indicates, for example a direction D3 for moving an object across the angled micro-wires 54. FIG. 6 illustrates an alternative micro-wire 50 arrangement with a single angled micro-wire 54 and an associated direction D3 for moving an object. The detection of touch locations and structures for single touches and for multiple sequential touches, or the detection of object structures that are swiped across a micro-wire 50 are known in the art and referenced above.

In a useful embodiment, the second electrodes 40 are used as first electrodes 30 using common processing hardware or software. As shown in FIGS. 1A and 2A, the second electrodes 40 are grouped together into groups. The second electrodes 40 labeled H6-H9 form a group HA, the second electrodes 40 labeled H10-H13 form a group HB, and the second electrodes 40 labeled H14-H17 form a group HC. These second electrode groups have the same number of micro-wires 50 as the first electrodes 30 H1-H5. Similarly, referring to FIG. 2A, the horizontal second electrodes H6-H9, form a group HA and the horizontal second electrodes 40 labeled H10-H13 form a group HB. As is also shown in FIG. 2A, the vertical second electrodes 40 labeled V8-V11 form a group VA, the vertical second electrodes 40 labeled V12-V15 form a group VB, and the vertical second electrodes 40 labeled V16-V19 form a group VC. These fourth electrode groups have the same number of micro-wires 50 as the third electrodes 32 V1-V7. Referring also to FIG. 7, in an embodiment, the electrical signals from the groups of second or fourth electrodes 40, 42 (not shown in FIG. 7) are electrically connected or combined for example through switching circuit 78 to form a common electrical signal that is processed, for example with controller 70 in the same way, or with the same circuits, as the electrical signals from the first electrodes 30. The combined electrical signal has the same spatial resolution as the electrical signals from the first electrodes 30 or third electrodes 32. Switching and combination circuits are known in the prior art, for example using tri-state drivers, analog transistors, operational amplifiers and the like.

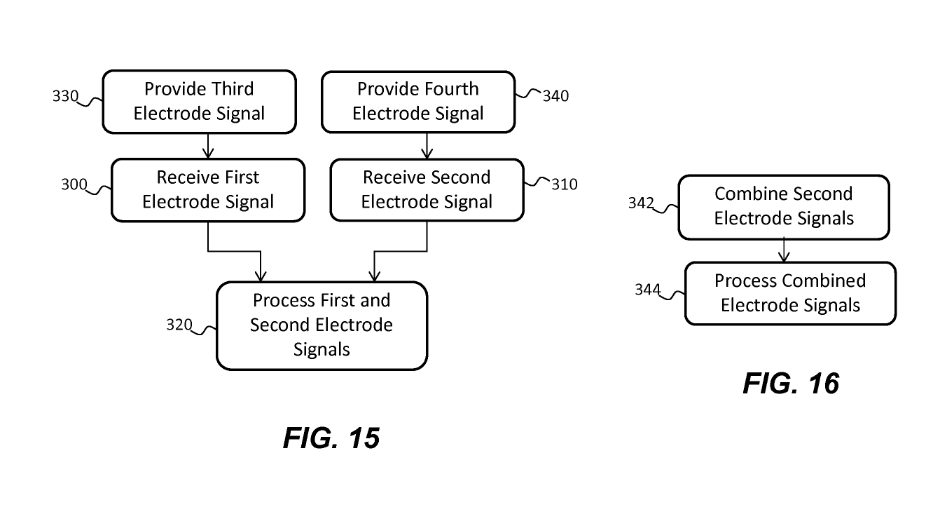

Alternatively, the electrical signals from groups of adjacent second electrodes 40 in either or both the horizontal or vertical directions are algorithmically combined, for example using the controller 70. Thus, processing circuitry in the controller 70 can process the electrical signals using hardware circuits or process the electrical signals using a stored program machine executing software. Such circuits and processors are well known in the art. Referring to FIG. 16, in step 342, electrical signals from the second electrode 40 are combined, either electrically for example with a switching circuit 78, or algorithmically with processing circuitry in the controller 70. The combined electrode signals are then processed in step 344, for example with processing circuitry in the controller 70.

According to embodiments of the present invention, the controller 70 can provide and receive electrical signals at a variety of frequencies. Electrical signals are provided by one group of electrodes, for example third electrodes 32 and fourth electrodes 42 and received by another group, for example first and second electrodes 30, 40. Alternatively, one group of second electrodes 40 provides electrical signals and a second group of adjacent second electrodes 40, a single second electrode 40, or a single angled micro-wire 54 receives electrical signals, for example as illustrated in FIGS. 3 and 4 wherein the angled micro-wire 54 (forming a second electrode 40) receives electrical signals. Alternatively, as illustrated in FIGS. 5 and 6, the angled micro-wires 54 (each forming a second electrode 40) provide electrical signals and the straight micro-wires 50 (each forming a second electrode 40) receive electrical signals.

In other embodiments, the controller 70 causes the first and third electrodes 30, 32 to operate at a first frequency and the second and fourth electrodes 40, 42 to operate at a second, different frequency, for example a second frequency greater than the first frequency. In a further embodiment, the controller 70 provides an electrical signal at a first frequency to one or more first electrodes 30 and receives an electrical signal from one or more second electrodes 40 at a second frequency different from the first frequency, for example a second frequency greater than the first frequency.

Thus, in an embodiment of the present invention, the first and second electrodes 30, 40 are used in a first operating mode to detect electrical signals corresponding to a single, common electrode spatial density. In this operating mode, the adjacent second electrodes 40 providing the combined signal have an area in at least one dimension that is equivalent to the area of the first electrodes 30 in the same dimension. In a different second operating mode the first electrodes 30 are used to detect electrical signals corresponding to a first electrode spatial density and the second electrodes 40 are used to detect electrical signals corresponding to a second electrode spatial density that is greater than the first spatial density.

Embodiments of the present invention provide multiple sensing functions for visually uniform micro-wire electrodes having different spatial resolutions while limiting the number of electrical connections 80. Higher spatial resolution sensing is provided for a portion of the surface area 12 and lower spatial resolution sensing is provided for the remainder of the surface area 12. Alternatively, the array of first and second electrodes 30, 40 can also provide sensing at the lower resolution for the entire surface area 12.

The electrically conductive micro-wires 50 of the present invention can be used to make electrical conductors and busses for electrically connecting transparent micro-wire electrodes to electrical connectors or controllers 70 such as integrated circuit controllers. One or more electrically conductive micro-wires 50 are used in a single substrate 10 and are used, for example in touch screens that use transparent micro-wire electrodes. The electrically conductive micro-wires 50 can be located in areas other than surface area 12, for example in the perimeter of the display area 111 of a touch screen 120, where the display 110 area is the area through which a user views a display 110.

The substrate 10 can be a rigid or a flexible substrate made of, for example, a glass or polymer material, can be transparent, and can have opposing substantially parallel and extensive surfaces 11. The substrate 10 can include a dielectric material useful for capacitive touch screens and can have a wide variety of thicknesses, for example 6 microns, 10 microns, 50 microns, 100 microns, 1 mm, or more. In various embodiments of the present invention, the substrate 10 is provided as a separate structure or is coated on another underlying support, for example by coating a polymer layer on an underlying glass support that is an element of another device. The substrate 10 can be an element of another device, for example the cover or substrate of a display 110 or a substrate or dielectric layer of a touch screen 120. Such substrates 10 and their methods of construction are known in the prior art. The substrate 10 of the present invention can include any material capable of providing a supporting surface on which micro-channels are patterned and formed. Substrates such as glass, metal, or plastic can be used and are known in the art together with methods for providing suitable surfaces. In a useful embodiment, the substrate 10 is substantially transparent, for example having a transparency of greater than 90%, 80% 70% or 50% in the visible range of electromagnetic radiation.

In an embodiment, the micro-wires 50 of the first and second electrodes 30, 40 are formed in a common process step and with common materials. Similarly, in an embodiment, the micro-wires 50 of the third and fourth electrodes 32, 42 are formed in a common process step and with common materials. Alternatively, different process steps and different materials can be used. The micro-wires 50 can be identical in cross section in any one or more of the first, second, third, and fourth electrodes 30, 40, 32, 42.

In various embodiments, the surface area 12 has a transparency greater than 70%, greater than 80%, or greater than 90%. The transparency of the surface area 12 is the percent of the surface area 12 that is not covered by micro-wires 50.

In other embodiments, one or more micro-wires 50 have a width of greater than or equal to 0.5 μm and less than or equal to 20 μm to provide an apparently transparent micro-wire electrode.

A variety of methods can be used to make the micro-wires 50. For example, the micro-wires 50 are printed, electro-plated, electrolessly plated, or imprinted. In an embodiment, the micro-wires 50 are applied as a liquid conductive ink and then cured. Some of these methods are known in the prior art, for example as taught in CN102063951 and 2014/0041924, which are hereby incorporated by reference in their entirety. As discussed in CN102063951, a pattern of micro-wires 50 is formed in a substrate 10 using an embossing or imprinting technique. Embossing or imprinting methods are generally known in the prior art and typically include coating a curable liquid, such as a polymer, onto a rigid substrate to form a curable layer. The polymer is partially cured (e.g. through heat or exposure to light or ultraviolet radiation) and then a pattern of micro-channels is imprinted (embossed or impressed) onto the partially cured polymer layer by a master having a reverse pattern of ridges formed on its surface. The polymer is then completely cured to form a cured layer with imprinted micro-channels. A conductive ink is coated over the cured layer and into the micro-channels. The excess conductive ink between micro-channels is removed, for example by using a squeegee, mechanical buffing, patterned chemical electrolysis, or patterned chemical corrosion. The conductive ink in the micro-channels is cured, for example by heating.

The micro-wires 50 can be metal, for example silver, gold, aluminum, nickel, tungsten, titanium, tin, or copper or various metal alloys including, for example silver, gold, aluminum, nickel, tungsten, titanium, tin, or copper. Other conductive metals or materials can be used. Alternatively, the micro-wires 50 can include cured or sintered metal particles such as nickel, tungsten, silver, gold, titanium, or tin or alloys such as nickel, tungsten, silver, gold, titanium, or tin.

The micro-wires 50 can be formed directly on the substrate 10 or over substrate 10 on layers formed on substrate 10. The words “on”, “over”, or the phrase “on or over” indicate that the micro-wires 50 of the present invention can be formed directly on a substrate 10, on layers formed on the substrate 10, or on either or both of opposing sides of the substrate 10. Thus, micro-wires 50 of the present invention can be formed under or beneath the substrate 10. “Over” or “under”, as used in the present disclosure, are simply relative terms for layers located on or adjacent to opposing surfaces 11 of the substrate 10. By flipping the substrate 10 and related structures over, layers that are over the substrate 10 become under the substrate 10 and layers that are under the substrate 10 become over the substrate 10.

A variety of micro-wire patterns can be used according to various embodiments of the present invention. The micro-wires 50 can be formed at the same or different angles to each other, can intersect each other, can be parallel, can have different lengths, or can have replicated portions or patterns. Some or all of micro-wires 50 can be curved or straight and can form line segments in a variety of patterns. The micro-wires 50 can be formed on opposing sides of the same substrate 10 or on facing sides of separate substrates 10 or some combination of those arrangements. Such embodiments are included in the present invention.

In an example and non-limiting embodiment of the present invention, each micro-wire 50 is from 5 microns wide to one micron wide and is separated from neighboring micro-wires 50 by a distance of 20 microns or less, for example 10 microns, 5 microns, 2 microns, or one micron.

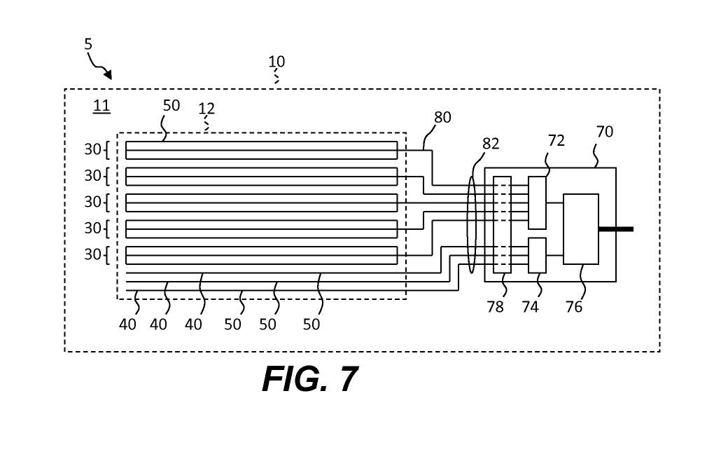

Referring to FIG. 8, in an embodiment of the present invention, the micro-wire electrode structure 5 is constructed by first providing a support in step 200 and providing an imprint stamp in step 205. The imprint stamp has a pattern of structures complementary to micro-channels in which the micro-wires 50 are formed. The support is coated with a curable layer in step 210 that is imprinted with the imprint stamp in step 215 and cured in step 220 to form the desired micro-channels in the cured layer. The cured layer and the support form the substrate 10. The substrate 10 and micro-channels are coated with a conductive ink in step 225 and excess conductive ink from the substrate 10 surface 11 removed in step 230. The conductive ink remaining in the micro-channels is cured in step 235 to form the micro-wires 50. The process of imprinting micro-channels in a curable layer on a support, curing the curable layer to form a cured layer with a pattern of micro-channels, filling the micro-channels with conductive ink, and curing the conductive ink to form micro-wires is known in the art, as are the required materials.

The conductive inks can include nano-particles, for example silver, in a carrier fluid such as an aqueous solution. The carrier fluid can include surfactants that reduce flocculation of the metal particles. Typical weight concentrations of the silver nano-particles range from 30% to 90%. Because of its high density, the volume concentration of silver in the solution is much lower, typically 4-50%. Once deposited, the conductive inks are cured, for example by heating. After filling micro-channels with this conductive ink solution, the carrier fluid evaporates, resulting in a silver micro-wire 50 in the micro-channel. The curing process drives out the solution and sinters the metal particles to form a metallic electrical conductor. The actual final silver thickness of silver micro-wire 50 depends on the filling method and silver concentration in the conductive ink solution. Conductive inks are known in the art and are commercially available.

Conductive inks or other conducting materials are conductive after they are cured and any needed processing completed. Deposited materials are not necessarily electrically conductive before patterning or before curing. As used herein, a conductive ink is a material that is electrically conductive after any final processing is completed and the conductive ink is not necessarily conductive at any other point in micro-wire 50 formation process.

Methods and devices for forming and providing substrates, coating substrates, patterning coated substrates, or pattern-wise depositing materials on a substrate are known in the photo-lithographic arts. Likewise, tools for laying out electrodes, conductive traces, and connectors are known in the electronics industry as are methods for manufacturing such electronic system elements. Hardware controllers for controlling touch screens and displays and software for managing display and touch screen systems are well known. These tools and methods can be usefully employed to design, implement, construct, and operate the present invention. Methods, tools, and devices for operating capacitive touch screens can be used with the present invention.

The present invention is useful in a wide variety of electronic devices. Such devices can include, for example, OLED displays and lighting, LCD displays, plasma displays, inorganic LED displays and lighting, electrophoretic displays, electrowetting displays, and smart windows.

The invention has been described in detail with particular reference to certain embodiments thereof, but it will be understood that variations and modifications can be effected within the spirit and scope of the invention.

### PARTS LIST

D1 first direction

D2 second direction

D3 movement direction

EA, EB, EC groups

HA-HC electrodes

S separation

VA, VB, VC groups

W width

W1 width

W2 width

X x-dimension

Y y-dimension

5 micro-wire electrode structure

10 substrate

11 surface

12 surface area

30 first electrode (H1-H5)

32 third electrode (V1-V7)

34 gap

40 second electrode (H6-H17)

42 fourth electrode(V8-V19)

50 micro-wire

54 angled micro-wire

60 first common layer

62 second common layer

70 controller

72 first control circuit

74 second control circuit

76 selection circuit

78 switching circuit

80 electrical connection

Parts List (con't)

82 bus

100 display and touch screen system

110 display

111 display area

120 touch screen

122 first transparent substrate

124 transparent dielectric layer

126 second transparent substrate

128 first pad area

129 second pad area

130 first transparent electrode

132 second transparent electrode

134 wires

136 electrical buss

140 touch-screen controller

142 display controller

150 micro-wire

156 micro-pattern

200 provide support step

205 provide imprint stamp step

210 coat support step

215 imprint substrate with stamp step

220 cure coated substrate step

225 coat substrate and fill channels with ink step

230 clean substrate step

235 cure ink step

300 receive first electrode signal step

310 receive second electrode signal step

320 process first and second electrode signals step

330 provide third electrode signal step

340 provide fourth electrode signal step

Parts List (con't) 342 combine second electrode signals step 344 process combined electrode signals step

1. A method of operating a micro-wire electrode structure having first micro-wire electrodes providing a first spatial electrode resolution and second micro-wire electrodes providing a second spatial electrode resolution greater than the first spatial electrode resolution to detect first and second spatial electrode resolution signals, comprising:
using a controller to receive an electrical signal from one or more first electrodes having visually uniform micro-wires arranged on a surface in a surface area, each first electrode including two or more electrically connected micro-wires in the surface area providing the first spatial electrode resolution; and
using the controller to receive an electrical signal from one or more second electrodes having visually uniform micro-wires arranged on the surface in the surface area, each second electrode including one or more electrically connected micro-wires in the surface area providing the second spatial electrode resolution greater than the first spatial electrode resolution, wherein the second electrodes have a smaller electrode area and a smaller micro-wire area than the first electrodes in the surface area and the first and second electrode areas are visually uniform; and
detecting the first spatial-resolution signal from the first electrode(s) and detecting the second spatial-resolution signal from the second electrode(s).

2. The method of claim 1, further including:
using the controller to provide an electrical signal to one or more third electrodes having micro-wires visually uniformly arranged on the surface in the surface area, each third electrode including two or more electrically connected micro-wires in the surface area; and
using the controller to provide or receive an electrical signal to one or more fourth electrodes having micro-wires visually uniformly arranged on the surface in the surface area, each fourth electrode including one or more electrically connected micro-wires in the surface area, wherein the fourth electrodes have a smaller electrode area and a smaller micro-wire area than the third electrodes in the surface area and the third and fourth electrode areas are visually uniform.

3. The method of claim 2, further including using the controller to process the low-spatial-resolution signal to detect a touch location in the surface area and using the controller to process the high-resolution signal to detect a physical signal.

4. The method of claim 3, further including touching the surface area at a location, touching the surface area at a multiple locations at different sequential times, touching the surface area with an object having an outline, touching the surface area with an object having a structure, or touching the surface area at a single location with different portions of the object at different sequential times to provide the physical signal.

5. The method of claim 4, further including using the controller to process the physical signal to determine a location, to determine a path, to determine an outline, or to determine a structure.

6. The method of claim 4, wherein the object is a finger, a hand, or a writing implement, wherein the path is a signature or a graphic, or wherein the structure is a fingerprint.

7. The method of claim 1, further including switching or combining the electrical signals from adjacent second electrodes to form a common electrical signal.

8. The method of claim 7, wherein the adjacent second electrodes have a surface area in at least one dimension that is equivalent to the surface area of the first electrodes in the same dimension.

9. The method of claim 7, wherein the controller includes processing circuitry and further including processing the common electrical signal and one or more of the electrical signals received from the one or more of the first electrodes with the same processing circuitry.

10. The method of claim 9, wherein the processing circuitry processes the electrical signals using hardware circuits or processes the electrical signals using a stored program machine executing software.

11. The method of claim 1, further including using the controller to provide an electrical signal at a first frequency to one or more first electrodes and using the controller to provide an electrical signal to one or more second electrodes at a second frequency different from the first frequency.

12. The method of claim 11, wherein the second frequency is greater than the first frequency.

13. The method of claim 11, further including using the controller to provide an electrical signal at a first frequency to one or more first electrodes and using the controller to receive an electrical signal from one or more second electrodes at a second frequency different from the first frequency.

14. The method of claim 11, wherein the second frequency is greater than the first frequency.

15. The method of claim 1, further including providing a signal to a second electrode and receiving a signal from one or more different second electrodes.
